(19) United States
(12) Patent Application Publication
(10) Pub. No.: US 2020/0065867 A1
(43) Pub. Date: Feb. 27, 2020

(54) PATENT VALUATION SYSTEM

(71) Applicant: FOSHAN CITY MU JI INFORMATION TECHNOLOGY LTD., Foshan City (CN)

(72) Inventors: Melvin Lim, Foshan City (CN); Lie Xin Lin, Foshan City (CN); Wen Feng Hou, Foshan City (CN); Jin Zhao, Foshan City (CN); Ping Zhang, Foshan City (CN)

(73) Assignee: FOSHAN CITY MU JI INFORMATION TECHNOLOGY LTD., Foshan City (CN)

(21) Appl. No.: 16/549,953

(22) Filed: Aug. 23, 2019

(30) Foreign Application Priority Data
Aug. 23, 2018 (CN) 201810968417.5
Aug. 9, 2019 (CN) 201910734927.0

(51) Int. Cl. G06Q 30/02; G06Q 50/18; G06F 16/182

(52) U.S. Cl. CPC G06Q 30/0278; G06F 16/1834; G06Q 50/184

(57) ABSTRACT

The present invention relates to a method of valuing patents, comprising the following steps: (a) Establishing a dynamic database; (b) obtaining and identifying patent information; (c) calling targeted information from the dynamic database in regard of the identified patent information to consequently form a target pool of data; (d) establishing representative valuation parameters and comparing these representative valuation parameters against the identified patent information together with the target pool of data; additionally, using mathematical models to quantify and assign scores to these valuation parameters and (e) aggregating the assigned scores of each of the valuation parameters and providing an overall valuation based on the aggregated scores.

### BENEFIT CLAIMS

This application claims the benefit of Chinese invention patent applications CN201810968417.5 filed 23 Aug. 2018, and CN201910734927.0 filed 9 Aug. 2019.

### TECHNICAL FIELD

The present invention is in the field of patent valuation, specifically, a system for the valuation of patents.

### BACKGROUND

The process of valuing intangible assets (for instance, patents) is based on a purposeful, fair and legal standard framework; suitable valuation methods seek to affirm or assign a reported value to patents. Such a valuation process is generally carried out by an expert human valuer, automated software systems or a combined effort of both.

In valuation processes carried out by either one or more expert human valuers, the differential treatment of relevant information influenced by opinions can result in values of different extent being assigned to a patent. In recent years, the annual number of patent applications has reached the multi-million mark while the number of granted patents has reached the million mark. With commercial activities related to the valuation of patents on the increase, valuation of low efficiencies as carried out by human effort can no longer satisfy the requirements of such activities. When a patent is to be valued against another set of technology (as uncovered by an expert in the related field), the valuer requires a relatively long time to carry out the valuation based on his or her valuation strategy and information available on the Internet. Furthermore, because any state of art changes in a rapid, dynamic fashion, the valuer may also face difficulties to assess readily up to date information on the Internet or a relevant database. In regard of this, the result of the desired valuation result may be affected or restricted.

In valuation processes that are carried out by automated software systems, current systems compare a technology desired to be evaluated against a group of identified technologies; the evaluation includes the analyses of technological, legal and market factors. This process involves the transformation of analyzed factors by eradicating the unquantifiable components; these components induce a reduced number state of parameters useful for the valuation process. Such a reduced number state of parameters can further cause volatility in the result of a valuation procedure, and therefore can only provide valuation results of limited usefulness. Although some automated software systems consider unquantifiable components, they unfortunately do not explicitly indicate the workings of these components, thereby presenting results of limited practicability only. For instance, there may be a lack of consideration in regard of the relatedness of each factor used in the valuation process, therefore causing the double accounting of these factors which results in the over-weightage of each considered factor in the valuation process; the end result of valuation in this case can only provide results of limited usefulness.

In valuation processes that are carried out using a combination of human expertise with automated systems, quantifiable factors are accounted for by a software automated valuation procedure while the unquantifiable factors are considered through human expertise. Because human expertise requires a judgmental approach in the consideration of both quantifiable and unquantifiable factors, the valuation result of any two expert opinions are therefore different. Furthermore because such expert opinions are essentially human effort, the valuation process that can be carried out is of a limited efficiency only.

The different, current valuation methods (i.e., based on human expertise, automated software systems or a combined form of both) each rely on different valuation parameters. These parameters reflect the human expert's (or software programmer's) perception of value. These lead to opinionated valuations, a lack of inclusion of unquantifiable parameters, impracticable steps (or methodologies) of valuation, or the lack of delinking of valuation parameters that are non-independent (or conversely, the lack of a lumping of valuation parameters which are considered similar). Furthermore, the identification of comparable technologies by either the human expert or software programmer may be restrictive in nature because the process is inevitably based on an individual perception as to what is considered “comparable”. Yet furthermore, one of the short-comings of the current state of art is also a lack of the inclusion of patent-related information in the identified and comparable technologies. Overall, the currently available methods of valuing patents present unsolved issues in regard of seeking valuations which are objective and representative. Improvement and solutions are sought to these aforementioned issues discussed. In view of this, the presently disclosed technology is put forth.

### SUMMARY

In the aspect of the present application, there is provided a method of valuing patents, comprising the following steps:
(a) Establishing a dynamic database;
(b) obtaining and identifying patent information;
(c) calling targeted information from the dynamic database in regard of the identified patent information to consequently form a target pool of data;
(d) establishing representative valuation parameters and comparing these representative valuation parameters against the identified patent information together with the target pool of data; additionally, using mathematical models to quantify and assign scores to these valuation parameters;
(e) aggregating the assigned scores of each of the valuation parameters and providing an overall valuation based on the aggregated scores.

The patent information as obtained in step (b) of the aspect may further comprise bibliographic details and patent claims; the patent information as identified further comprises classification codes within the bibliographic details together with keywords from the patent claims. Yet further, the target pool of data as formed in step (c) comprises a record of patents generated based on classification codes and/or keywords and a databank of technological knowledge generated based on keywords.

The step of calling of targeted information in step (c) of the aspect in regard of the identified patent information may comprise the actions of searching, statistically analyzing and querying the dynamic database.

The step of establishing representative valuation parameters in step (d) of the aspect may comprise the creation of both quantifiable and unquantifiable indicators.

The representative valuation parameters as mentioned in the aspect may comprise of legal, technological and market valuation parameters. Further to this, the legal valuation parameters may comprise of the remaining years of patent protection, unity of invention, drafting quality, grant rate, historical legal status and/or novelty of invention; the technological valuation parameters may comprise the research experience and background of the patent applicant(s) or inventor(s) in the relevant technological field, patent citation(s), duration of patent application process, practicability of technology, how advanced a technology is, how versatile a technology is and if the patented technology has garnered any technological prize; the market valuation parameters may comprise details of the patent applicant(s), whether the patent applicant(s) is/are in a field related to the patent in consideration, market boundaries/conditions/strategies, license(s) issued, assignment(s) and the annual maintenance of the patent.

The representative valuation parameters as mentioned within the aspect may be further subject to a multiple regression model and optimized using a least-squares method Y=βX+ε; Y is the dependent variable matrix, X is the independent variable matrix, β is the coefficient matrix, ε is the residual matrix; β=(X′X)⁻¹(X′Y); X′ is the transpose matrix of X.

Yet further, an analysis of the independence between the representative valuation parameters is carried out through a likelihood function:

$$\{ \begin{matrix}LR 1 = - \frac{n}{2} \times ln ( 2 π \hat{σ} ) - {\sum }_{i} {( \frac{{ɛ}^{2}}{2 \hat{σ}} )}_{i} \\ LR 2 = - \frac{n}{2} \times ln ( 2 π \tilde{σ} ) - {\sum }_{i} {( \frac{{ɛ}^{2}}{2 \tilde{σ}} )}_{i} \\ LR = 2 [ LR 1 - LR 2 ]\end{matrix}$$

where LR1 refers to the likelihood function of an unconstrained equation, n is a selected number of data points, ∂ is the estimated variance of the unconstrained equation; LR2 refers to the likelihood function of a constrained equation, \tilde{σ} is the estimated variance of the constrained equation; LR1 and LR2 follow a chi-square distribution; n, i are both positive whole numbers.

The dynamic database as established in step (a) of the aspect may be one of the nodes of at least one blockchain. Furthermore, data maintenance within the dynamic database may be carried out by at least one of the participating nodes of the said at least one blockchain. Yet furthermore, the participating nodes form a blockchain alliance.

The said patent information as obtained and identified in step (b) of the aspect may be of at least one language.

The dynamic database as established in step (a) of the aspect may consist of data in at least one language.

The dynamic database as established in step (a) of the aspect may be established as an interface to at least a patent transaction platform.

The method described of the aspect may comprise a further step in which a monetary value is assigned based on the overall valuation.

The steps in the method as described in the aspect may be carried out on one or more data servers.

The steps in the method as described in the aspect may be carried out using at least one computing device.

The steps in the method as described in the aspect may be carried out using at least a single, dedicated computing device.

The steps in the method as described in the aspect may be hosted on at least a single, dedicated data server.

### Definitions

The following words and terms used herein shall have the meaning indicated:

Unless specified otherwise, the word “patent” or “patents” is to be taken to encompass reference to a patent or patents, and a patent application or patent applications.

The terms “Technical Field”, “Description of Invention”, “Figures”, “Embodiments” and “Background” sections used throughout the present application should be understood as that of having synonymous or equivalent sections, for example, an equivalent of “Technical Field” may be “Field of Invention”, while an equivalent of “Figures” may be “Diagrams”.

The words “essentially” and “substantially” do not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

Unless specified otherwise, the word “similar” is to be inferred as “comparable”.

Throughout this disclosure, certain embodiments may be disclosed in a range format. It should be understood that the description in range format is merely for convenience and brevity and should not be construed as an inflexible limitation on the scope of the disclosed ranges.

Accordingly, the description of a range should be considered to have specifically disclosed all the possible sub-ranges as well as individual numerical values within that range. For example, the description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DISCLOSURE OF OPTIONAL EMBODIMENTS

Exemplary, non-limiting embodiments according to the single aspect will now be disclosed.

In an embodiment of the aspect, there is provided a method of valuing patents, comprising the following steps (a) to (e):

(a) Establishing a Dynamic Database.

The dynamic database as established may be one of the nodes of at least one blockchain. Data maintenance within the dynamic database may be carried out by at least one of the participating nodes within the at least one blockchain; the participating nodes may be for e.g., the Applicant or other business entities, government organizations or other entities possessing relevant data which form a blockchain alliance, enabling the dynamic database to be updated on a regular or real time basis with technical articles, patent specifications and other resources. In this manner, the stability and reliability of the dynamic database is ensured, and the cost associated with the maintenance of such a dynamic database may be reduced; these lead to a lesser required effort in handling a dynamic database. The dynamic database is updated with the passing of time; data is provided by multiple parties that provide authenticated and updated data, thus ensuring the accuracy and completeness of the dynamic database.

In an embodiment, the dynamic database as established in step (a) of the aspect may consist of data in at least one language. Advantageously, this allows for raw data in various languages from a range of patent jurisdictions of different countries to be used in the establishment of the dynamic database.

In an embodiment, the patent information as obtained and identified in step (b) of the aspect may be in at least one language. Advantageously, this allows for the versatility of patent information in various languages from a range of patent jurisdictions of different countries to be obtained and identified.

In an embodiment, the dynamic database as established in step (a) of the aspect is established as an interface to at least a patent transaction platform. Advantageously, such an interface not only provides completes the framework for the trading and/or licensing of patents, but also presents the ability to calculate a value of a patent based on a standardized quantification process. This thus eliminates the need for costly and labor intensive valuation procedures in the framework which inadvertently must require opinions from a human valuer.

(b) Obtaining and Identifying Patent Information.

Step (b) of the aspect involves the obtaining of patent information, including bibliographic details and patent claims; the obtained patent information may further comprise text and diagrams from a patent specification. The identified patent information may include the International Patent Classification (IPC) codes from the bibliographic details; furthermore, it may also include the following: patent numbers, dates, patent application numbers, dates of application, priority information, international application statuses, applicants, inventors, patent agents and agencies, examiners, prior art documents and keywords (further identifying the technological features within the keywords). The language of the patent specification may be of any language, for e.g., Chinese, English, French, German or Russian, etc. Where necessary, an online translation process may be used to effect the required translation prior to the obtaining and identifying of the patent information. While the identified patent information may exemplarily be IPC type classification codes as mentioned earlier, other similar systems like the European Classification System (ECLA), Current US Class Number (CCS), Japanese FI (File Index)/F-term (File forming Term), or Cooperative Patent Classification (CPC) may also be used accordingly.

(c) Calling Targeted Information from the Dynamic Database in Regard of the Identified Patent Information to Consequently Form a Target Pool of Data;

The targeted information mentioned in step (c) may comprise IPC type classification codes and/or historical patent or technological know-how databases generated based on the use of keywords. The use of the IPC type classification codes together with the keywords are important to establish the state-of-the-art technology and in searching for the boundaries of comparable data; searches coupling multiple search parameters advantageously compensate for the mere use of patent specifications as the search parameter even though patent specifications make up approximately 90% of the world's scientific information, with the remainder found in technical periodicals and confidential information (trade secrets). More specifically, historical patent databases consist of published patent specifications while technology databases consist of technical periodicals. Overall, historical patent databases and technology databases make up the current state-of-art. In comparison to valuation frameworks that use patent specifications as the only representation of the state-of-art, the use of a combination of historical patent databases and technology databases to represent the state-of-art advantageously provides a better defined scope of relevant technology; this may further be better suited to pre-judging the novelty of a patent application when valuing such a patent application. The as abovementioned improvements to the dynamic database and target pool of data synergistically ensures the completeness of the raw data used and accuracy of any compared data. A valuation process that uses such improved data is advantageously able to provide more accurate and objective valuation results.

In step (c), the calling of the targeted information may comprise at least searching, counting and query commands which overall dictate the obtaining of targeted information from the dynamic database to form the as-mentioned targeted pool of data. Other than information pertaining to the state-of-art, the target pool of data can further comprise of statistics related to the claims of the patent and the total word count of the patent specification or number of included diagrams; furthermore, it can also further comprise of information from the patent register, company details and expert information database (these being obtained based on the patent application number); yet furthermore the target pool of data may also comprise applicant and inventors' details, patent agent and patent agency's details to determine the grant rate of both the applicant and the patent agent/agency; yet even furthermore the target pool of data can comprise queried and counted information relevant to the patent to be valued. Consequently the target pool of data may be formed based on an indexed form of the various information sources mentioned herein. The use of such an indexed form of data when coupled with the use of big data analyses to query and count information in a patent to be valued (and its comparable equivalent patents) advantageously reduces the overall process time required for the method described in the aspect, thereby increasing the process efficiency.

(d) Establishing Representative Valuation Parameters and Comparing These Representative Valuation Parameters Against the Identified Patent Information Together with the Target Pool of Data; Additionally, Using Mathematical Models to Quantify and Assign Scores to These Valuation Parameters.

In step (d), the as-mentioned representative valuation parameters include both quantifiable and unquantifiable valuation parameters. Quantifiable valuation parameters allow information as recognized from patent specifications to be compared and analyzed against the target data pool. Furthermore, these quantifiable valuation parameters may be fitted with mathematical model(s). In the case of unquantifiable valuation parameters, these parameters are first transformed into closely related and quantifiable parameters. These as transformed parameters may then be used to allow information as recognized from patent specifications to be compared and analyzed against the target data pool. Advantageously, the transformation of quantifiable parameters from unquantifiable parameters solves an existing problem in the art in which unquantifiable valuation parameters are not considered; this thereby provides a more wholesome valuation framework. From the valuator's point of view, this removes the subjectivity of unquantifiable parameters and therefore ensures a more objective/fair evaluation and analysis. Overall, advantageously, any unquantifiable valuation parameters may be quantified objectively; the valuation system thus provides a method of evaluating unquantifiable parameters in a highlypractical manner.

In step (d), the as-mentioned representative valuation parameters may be at least classified into legal, technological and market valuation parameters. These valuation parameters may also be subdivided into both quantifiable and unquantifiable parameters; furthermore they may also be fitted with mathematical model(s).

The legal valuation parameters (both quantifiable and unquantifiable in nature) include at least the following: remaining number of years of patent protection, unity of invention, patent draft quality, grant rate, legal history and/or novelty. The market valuation parameters (both quantifiable and unquantifiable in nature) include at least the following: applicant details, applicant's related invention fields, addressable market, market conditions, to-market strategy, patent licensing, patent assignment and patent maintenance. The market technological parameters (both quantifiable and unquantifiable in nature) include at least the following: applicant's research experience within the considered field, inventor's research experience within the considered field, number of citations, time taken for patent to be granted, practicability of technology, how advanced a technology is, how widespread a technology is utilized and whether the technology is an award-winning technology. By comprehensively considering and analysing the contribution of various parameters on patent value, including various direct or indirect parameters which affect patent value and understanding any correlation (or independence) between these parameters, the valuation process is advantageously rendered more objective.

In another embodiment, the as-mentioned representative valuation parameters include a risk module. The risk module consists of both quantifiable and unquantifiable risk parameters, and includes at least the following forms of risk: patent work-around, ability to gather evidence of infringement, ease of technology substitution and legally contentious matters.

The values of the earlier mentioned parameters may deviate about central values. If this deviation in values is of a normal distribution, depending on the accuracy of the relevant data, the multiple regression model may then be used to fit the relevant data and the least squares method may used for optimization purposes, Y=βX+ε, where Y is a dependent variable matrix, X is an independent variable matrix, β is the coefficient matrix, ε is the residual matrix, β=(X′X)⁻¹(X′Y) and X′ is the transposition of X.

Due to a potential correlation among the considered valuation parameters of legal, technical and market valuation parameters, the maximum likelihood function can be introduced to determine the regression of these parameters and to analyze the independence of the indicators:

$$\{ \begin{matrix}LR 1 = - \frac{n}{2} \times ln ( 2 π \hat{σ} ) - {\sum }_{i} {( \frac{{ɛ}^{2}}{2 \hat{σ}} )}_{i} \\ LR 2 = - \frac{n}{2} \times ln ( 2 π \tilde{σ} ) - {\sum }_{i} {( \frac{{ɛ}^{2}}{2 \tilde{σ}} )}_{i} \\ LR = 2 [ LR 1 - LR 2 ]\end{matrix}$$

where LR1 refers to the likelihood function of an unconstrained equation, n is a selected number of data points, ∂ is the estimated variance of the unconstrained equation; LR2 refers to the likelihood function of a constrained equation, \tilde{σ} is the estimated variance of the constrained equation; LR1 and LR2 follow a chi-square distribution; n, i are both positive whole numbers.

If the influence of one independent variable on the original equation exceeds the chi-square χ² critical value, it is then deduced that the effect of eliminating this independent variable from the equation is not negligible. When two variables with strong correlation in the equation coexist, in the event that one is eliminated and because of the existence of the other, it will not have a significant effect on the equation. In this manner, a dimensionality reduction may be achieved; this will advantageously result in a reduction in the computational effort required when a computing device is used to carry out the method of the present application. In an embodiment, the implementation of the multiple regression models and the maximum likelihood functions may also be through the use of a computing device.

(e) Aggregating the Assigned Scores of Each of the Valuation Parameters and Providing an Overall Valuation Based on the Aggregated Scores.

The value of each valuation parameter under the legal valuation parameter, technical valuation parameter and market valuation parameter is calculated separately, and their individual scores derived. The sum of the individual scores is deemed as the value of the patent; finally, an valuation report is generated. The valuation report may be downloaded and viewed in an online or offline mode; as a hardcopy, softcopy or both.

In an embodiment, the method of valuing patents further comprises the step of forming a database consisting of patent values according to pre-evaluated patent values. Furthermore, an application program interface (API) may accordingly be provided for external users or internal use of such a database consisting of patent values.

In an embodiment, after the patent valuation process is carried out, the information as contained within the valuation reports further form a database of such information. A blockchain is introduced into the database, and data is maintained in multiple nodes. The nodes synchronize data based on the blockchain, thereby advantageously ensuring data security and credibility; the risk of data loss and data tampering is reduced. The method of valuing patents as put forth may also be applied to a technology trading platform built on blockchain technology and smart contracts by providing reference for the value of patents.

In an embodiment, the basic quantification process for each valuation parameter may be as follows:

I. Legal Value (Score L)

1. Residual Protection Life (Score Weightage l₁)

An invention patent is granted protection for 20 years, while a utility model patent is granted protection for 10 years. The longer the remaining period of protection, the higher the patent value is deemed.
(a) Invention patent: remaining years of protection being Y₁,

$${L}_{1} = \frac{100 {Y}_{1}}{20}$$

(b) Utility model patent: remaining years of protection being Y₁,

$${L}_{1} = \frac{100 {Y}_{1}}{10}$$

2. Number of Applicants (Score Weightage l₂)

A patent has at least one named applicant. In the case of more than one applicant, the rights to the patent are relatively more complex and the degree of autonomy associated with each applicant's rights are lower. In such a manner, the relevant value score is accordingly lower as well. Where P₁ refers to the total number of applicants, with each additional applicant resulting in the subtraction of a score of q₁:

L₂=100−q₁×(P₁−1), (L₂≥0)

3. Novelty (Score Weightage l₃)

The novelty of a patent application (invention or utility model patent) is not quantifiable before the application is substantively examined. However, it can be ascertained after substantive examination is completed.
(a) Before substantive examination is completed: Relevant prior art patent documents before the application date are retrieved according to their IPC type classes. Furthermore, technical journal articles before the application date of the patent are retrieved according to keywords. Other than the priority application claimed by the pending patent application, if all the technical features of the pending patent application fall within the scope of the existing technology, the patent application is then considered not to exhibit novelty, and

L₃=1

If novelty is assessed to be present,

L₃=99
(b) After substantive examination is completed: In the cases where a patent is granted or an office action (examination report) has issued where the novelty of the patent application is not raised as an issue by the examining authority, novelty is deemed to be present, and:

L₃=100

Where matters regarding novelty is raised as an issue by an examining authority, novelty is deemed to be lacking, and:

L₃=0

4. Rate of Grant (Score Weightage l₄)

Pre-Examination:

For a utility patent application, it is defined as the preliminary examination stage.

For an invention patent application, it is defined as the stage before it undergoes substantive examination.

Post-Examination:

For a utility patent application, it is defined as the stage after the preliminary examination stage.

For a invention patent application, it is defined as the time after it undergoes substantive examination.
(a) Pre-Examination
   (i) The total number of patents applied for by the applicant in relevant IPC type classes is y₁, the number of patents granted is x₁; the rate of grant for the applicant is given by:

$${L}_{41} = \frac{100 {x}_{1}}{{y}_{1}}$$

(ii) The total number of patents with a particular named inventor for relevant IPC type classes is y₂, the number of patents granted is x₂; the rate of grant for the inventor is given by:

$${L}_{42} = \frac{100 {x}_{2}}{{y}_{2}}$$

(iii) The total number of patents represented by a patent agency for relevant IPC type classes is y₃, the number of patents granted is x₃; the rate of grant for the patent agency is given by:

$${L}_{43} = \frac{100 {x}_{3}}{{y}_{3}}$$

(iv) The total number of patents represented by a patent agent for relevant IPC type classes is y₄, the number of patents granted is x₄; the rate of grant for the patent agent is given by:

$${L}_{44} = \frac{100 {x}_{4}}{{y}_{4}}$$

(v) The total number of patents examined by a patent examiner for relevant IPC classes is y₅, the number of patents allowed for grant is x₅; the rate of grant of the examiner is given by:

$${L}_{45} = \frac{100 {x}_{5}}{{y}_{5}}$$

Where the patent applicant's associated score for the rate of grant is N₁, inventor's associated score for the rate of grant is N₂, patent agency's associated score for the rate of grant rate is N₃, patent agent's associated score for the rate of grant is N₄, examiner's associated score for the rate of grant is N₅, with (N₁+N₂+N₃+N₄+N₅=100%), L₄ is then defined as:

L₄=N₁×L₄₁+N₂×L₄₂+N₃×L₄₃+N₄×L₄₄+N₅×L₄₅
(b) Post-Examination
   Where a patent is granted,

L₄=100
When the patent is not granted,

L₄=0

5. Quality of Patent Specification as Drafted (Score Weightage l₅)
(a) Drawings included in the patent specification: The average number of pages consisting of diagrams within patents or patent applications of considered IPC type class or classes is K₁; the maximum score is Q₁, and the number of pages in the patent that is being valued is K₂. The relevant score that is attainable by the patent being valued is:

$${L}_{51} = \frac{{Q}_{1} \times {K}_{2}}{{K}_{1}} , ( 0 \leq {L}_{51} \leq 100 )$$

(b) Claims:
   (i) If excess claim fees were required to be paid,

L₅₁₁=20
If excess claim fees are not required to be paid,

L₅₁₁=0
(ii) It is presumed the more the number of claims present in the patent that is valued, the more comprehensive the scope of patent protection and that the claims may be more stable; the related score L522 is:

L₅₂₂=Z₁, (1≤L₅₂₂≤80)
Overall, L₅₂ is defined as:

L₅₂=L₅₂₁+L₅₂₂
(c) Claim coverage: Analyze each independent patent claim and identify whether the claim defines a product or process:
   (i) Where a product claim is present, the related score L₅₃₁ is as follows:

L₅₃₁=50
Where a product claim is not present,

L₅₃₁=0
(ii) Where a process claim is present, the related score L₅₃₂ is as follows:

L₅₃₂=50
Where a process claim is not present,

L₅₃₂=0
Overall, L₅₃ is defined as:

L₅₃=L₅₃₁+L₅₃₂
(d) Scope of protection: It is presumed that the lesser the number of words within a patent claim, the wider the scope of protection of the claim; the value score associated with such a claim is higher.
   (i) In the case of an independent patent claim, the lesser the number of words within the claim, the wider the scope of protection of the claim;
   (ii) In the case of an independent patent claim, the lesser the number of claimed technical features (technical features consist of keywords and descriptive words) present within the claim, the wider the scope of protection of the claim.

In the target data pool, the frequency of occurrence of keywords in the independent claim is associated with a score J₁; the extent of the descriptive nature of the same keywords is associated with a score J₂, and the word count of the independent claim is associated with a score J₃. J₁ is weighted by Z₂, J₂ is weighted by Z₃, J₃ is weighted by Z₄; (Z₂+Z₃+Z₄=100%). The score L₅₄ is defined as:

L₅₄=Z₂×J₁+Z₃×J₂+Z₄×J₃, (0≤J₁, J₂, J₃≤100, 0≤L₅₄≤100)
(e) Degree of completeness of patent specification: The technical features in the patent claims should also be mentioned elsewhere in the patent specification; the score associated with these technical features is x₆; the total number of technical features being x in the inventions; then L₅₅ is defined as:

$${L}_{55} = \frac{100 {x}_{6}}{x}$$

(f) Patent specification: Score associated with number of words in Technical Field section: X₁; score associated with number of words in Background section: X₂; score associated with number of words in the Description of Invention section: X₃; score associated with number of words in the Figures section: X₄; score associated with number of words in the Embodiments' section: X₅. The total number of words is: X. Corresponding mean values for the target pool of data are: X̅₁, X̅₂, X̅₃, X̅₄, X̅₅, X̅. Weightage for the score associated with the number of words in the Technical Field: n₁; weightage for the score associated with the number of words in the Background section: n₂; weightage for the score associated with the number of words in the Description of Invention section: n₃; weightage for the score associated with the number of words in the Figures section, n₄; weightage for the score associated with the number of words in the Embodiments' section: n₅. Furthermore:

n₁+n₂+n₃+n₄+n₅=100%

The score L₅₆ is defined as:

$${L}_{56} = {n}_{1} \times ( 1 - \vert \frac{{X}_{1}}{X} - \frac{\overline{{X}_{1}}}{\overline{X}} \vert ) + {n}_{2} \times ( 1 - \vert \frac{{X}_{2}}{X} - \frac{\overline{{X}_{2}}}{\overline{X}} \vert ) + {n}_{3} \times ( 1 - \vert \frac{{X}_{3}}{X} - \frac{\overline{{X}_{3}}}{\overline{X}} \vert ) + {n}_{4} \times ( 1 - \vert \frac{{X}_{4}}{X} - \frac{\overline{{X}_{4}}}{\overline{X}} \vert ) + {n}_{5} \times ( 1 - \vert \frac{{X}_{5}}{X} - \frac{\overline{{X}_{5}}}{\overline{X}} \vert )$$

The weightage for the score associated with the figures is S₁, the weightage for the score associated with the patent claims is S₂, the weightage for the score associated with the scope of the patent claims is S₃, the weightage for the score associated with the scope of protection of the patent claims is S₄, the weightage for the score associated with the degree of completeness of the patent specification is S₅, and the weightage for the score associated with the overall patent specification is S₆. Furthermore:

S₁+S₂+S₃+S₄+S₅+S₆=100%

The score associated with the quality of the patent specification is:

L₅=L₅₁×S₁+L₅₂×S₂+L₅₃×S₃+L₅₄×S₄+L₅₅×S₅+L₅₆×S₆

(6) Legal History (Score Weightage l₆)

Litigation and re-examination: Whether the patent has encountered rejection, invalidation, etc. In an embodiment, a patent application is rejected after passing the preliminary examination; the applicant then submits a response or makes amendments in regard of the rejection, and the patent is consequently granted; in another instance, a patent application is rejected after a substantive examination and the applicant submits a response or makes amendments which result in the consequent grant of the patent; in yet another instance, the patent encounters a third-party request to invalidate it and the relevant actions of the Patent Reexamination Board subsequently declares partial invalidity of the patent and maintains the validity of the remaining patent rights. The frequency of occurrence of such a favorable incident is x₇ and an associated score of Q₂ is added each time such an incident occurs. The number of patent claims affected by the incident is Z₅ while the total number of patent claims is Z (where Z₅<Z). With a starting basic score of B₁, the score associated with the legal history of the patent under consideration is:

$${L}_{61} = {B}_{1} - \frac{100 {Z}_{5}}{Z} + {Q}_{2} \times {x}_{7} , ( 0 \leq {L}_{61} \leq 100 ) ; ( 0 \leq {Q}_{2} \times {x}_{7} \leq 100 )$$

(a) Transfer of patent rights: When a patent has been licensed or assigned, it is a likely indication that the patent is relatively stable. The frequency of occurrence of licensing is x₈, and the frequency of occurrence of an assignment is x₉. Each occurrence of licensing attracts an associated score of Q₃ with a weightage of N. L₆₂ is defined as:

L₆₂=N×x₈Q₃+(100%−N)×x₉Q₃, (0≤L₆₂≤100); 0≤N≤100%

The weightage of the scores associated with licensing or an assignment is Nₛ. The score associated with the legal history of the patent is then:

L₆=Nₛ×L₆₁+(100%−Nₛ)×L₆₂, (0≤Nₛ≤100%)

Overall, l₁+l₂+l₃+l₄+l₅+l₆=100%; the overall score associated with the legal parameter of the patent being valued is:

L=L₁×l₁+L₂×l₂+L₃×l₃+L₄×l₄+L₅×l₅+L₆×l₆

II. Market Value (Score M)

1. Applicant's Information (Score Weightage of m₁)

Basic score B₂, registered capital H₁ (in tens of thousands), company size I₁ (number of people). For companies with the largest registered capital under the relevant IPC type class/classes as the patent being valued, the registered capital is G₁ (in tens of thousands); for the largest companies, there are F₁ employees, the maximum score of the registered capital is D₁. For a applicant who is a natural person, the associated score m₁ is:

m₁=B₂, 0≤B₂≤100

For an applicant that is a company, the associated score is:

$${M}_{1} = {B}_{2} + \frac{{D}_{1} {H}_{1}}{{G}_{1}} + \frac{[ 100 - ( {D}_{1} + {B}_{2} ) ] {I}_{1}}{{F}_{1}} , ( 0 \leq ( {D}_{1} + {B}_{2} ) \leq 100 )$$

2. Whether the Applicant is within a Related Industry (Score Weightage of m₂)
(a) Individual: associated score of M₂(=B₃).
(b) Company: a check is first carried out to garner relevant details of the company, particularly to establish if the scope of business of the company is related to the scope of the invention sought in the patent being valued. If so, the associated score is M₁(=B₄), otherwise, M₂=B₅. Furthermore, B₄>B₅>B₃. In the event that there is more than one applicant, the higher or highest score is considered.

3. Addressable Market (Score Weightage m₃)
(a) Whether a Patent Cooperation Treaty (PCT) has been filed: it is presumed that the filing of such an application is indicative of the desire to expand into an overseas market/markets. If filed, the associated score is as follows:

M₃=100

Otherwise,

M₃₁=0

The score weightage associated with M₃ or M₃₁ is E₁.
(b) Patent family: Total patent family members being y₆ with the associated score for each individual member (in each country) being Q₄, then:

M₃₂=Q₄y₆, (0≤M₃₂≤100)

4. Market Conditions (Weightage of m₄)

Because prevailing market conditions of a particular technology cannot be analyzed from the valuation parameters, they therefore are considered unquantifiable value(s). It is possible to effect a transformation of such unquantifiable value(s) through the use of big data analysis; firstly the unquantifiable items are transformed into a correlated quantifiable index. Further they are then analyzed and measured according to the correlated quantifiable index. Consequently, a quantifiable value(s) can be achieved though such a process.

The unquantifiable market conditions are first transformed into quantifiable parameters by utilizing the existing technology pool and related patent applications (as shown in FIG. 2) to allow related large-scale data analyses to be carried out. The quantifiable parameters are then analyzed and a quantified form of the originally unquantifiable market conditions is derived.

As depicted in FIG. 2, the total number of patent applications and total number of existing patents in the technology patent pool under the relevant IPC type class/classes are counted. For a technology in its infancy stage, the volume of the technology patent pool and patent applications are seen to be on the smooth rise. For a technology that is in a rapid stage of development, the trend for both exhibit sharp upward movements. A technology in a mature stage has an upward trend in the volume of the technology patent pool while the volume of patent applications appears to be rather stable. Technology in a declining stage of development has a smooth upward trend in the existing technology pool, but the volume of patent applications exhibits a sharp downward trend. In an embodiment, if the results from an analyses show that the related industry is in the infancy stage, the associated score M₄=a₁; if the industry is in a development stage, the associated score M₄=b₁; if the industry is in the mature stage, the associated score M₄=c₁; finally, when an industry is in a declining stage, then the associated score M₄=d₁. The embodiment as provided herein gives a detailed transformation process of originally unquantifiable market conditions. However it should be noted that such unquantifiable market conditions are not the only type of unquantifiable parameters; there are other parameters that may be present in originally unquantifiable form and they should be duly considered when carrying out a patent valuation process.

5. To-Market Strategy (Score Weightage of m₅)

In en embodiment, the number of granted invention patent/patents belonging to the applicant within the target pool of data is H₂, the number of granted utility model patent/patents belonging to the applicant within the target pool of data is I₂, the scope of protection of each invention patent has an associated score Aᵢ, the total number of all invention patents with the same IPC type class/classes as the patent to be valued is F₂, the total number of all utility model patents with the same IPC type class/classes as the patent to be valued is G₂, the scope of protection of each invention patent has an associated score Cᵢ and the upper scoring limit associated with the invention patent/patents is E₂, where:

(0≤E₂≤100)

The score Ms as associated with the to-market strategy is defined as:

$${M}_{5} = \frac{{E}_{2} [ {\sum }_{i = 1}^{{H}_{2}} {A}_{i} ]}{{\sum }_{i = 1}^{{F}_{2}} {C}_{i}} + \frac{( 100 - {E}_{2} ) [ {\sum }_{i = 1}^{{I}_{2}} {A}_{i} ]}{[ {\sum }_{i = 1}^{{G}_{2}} {C}_{i} ]}$$

6. Patent Licensing (Score Weightage of m₆)

Where a patent is licensed, it is indicative that the patent possesses market value; the larger the registered capital (or the larger the size) of the licensee company, the more likely the patent consists of higher quality technology.

The registered capital of the licensed company is H (in tens of thousands), the size of the company is I₃, the number of licenses is y₇, and the upper score of the company's registered capital is D₂. Based on the company with the largest registered capital (G₃) amongst all the companies within the same IPC type class/classes as the patent to be valued, in which this company has F₃ number of employees; each license issued by the company is associated with a score weightage of E₃.
(a) Where no license is issued, M₆=0;
(b) Where a license is issued:

$${M}_{6} = {\sum }_{i = 1}^{{y}_{7}} \{ {E}_{3} \times [ \frac{{D}_{2} {H}_{{3}_{i}}}{{G}_{{3}_{i}}} + \frac{( 100 - {D}_{2} ) {I}_{{3}_{i}}}{{F}_{{3}_{i}}} ] \} , \\ 0 \leq {M}_{6} \leq 100 ; 0 \leq {E}_{3} \leq 100 \%$$

7. Patent Assignment (Score Weightage of m₇)

Number of assignments carried out is y₈, each assignment is given a score weightage of E₄.

The number of invention patents or utility model patents held by the assignee company in the relevant field or fields of the patent being valued is assigned a score of Q₅.

In regard of the assignee company: the registered capital of the assignee company is H₄ (in tens of thousands), the number of people employed by the assignee company I₄, the upper score of the company's registered capital is E₅. The company with the largest registered capital (G₄) amongst all the companies within the same IPC type class/classes as the patent to be valued is considered; this company has F₄ number of employees.

Relatedness between assignee company and assigned patent: There is consideration as to whether the assignee company is related to the patent to be valued (particularly in regard of the scope of her business and products). If so, the associated score B₆ is as follows:

B₆=100

Otherwise,

B₆=0

The relatedness of the assignee company and the assigned patent carries a weightage of U₁, the state of the assignee company carries a weightage of U₂, the number of invention patents or utility model patents as held by the assignee company in the relevant field or fields of the patent being valued carries a weightage of U₃. And,

U₁+U₂+U₃=100%

The overall score associated with patent assignment is M₇. M₇ is defined as follows:

$${M}_{7} = {\sum }_{i = 1}^{{y}_{8}} \{ {E}_{4} \times [ {U}_{1} {B}_{{6}_{i}} + {U}_{2} ( \frac{{E}_{5} {H}_{{4}_{i}}}{{G}_{{4}_{i}}} + \frac{( 100 - {E}_{5} ) {I}_{{4}_{i}}}{{F}_{{4}_{i}}} ) + {U}_{3} {Q}_{{5}_{i}} ] \} , \\ 0 \leq {M}_{7} \leq 100 ; 0 \leq {U}_{1} \leq 100 \%$$

In the case where there is no patent assignment, then:

M₇=0

8. Annual Maintenance of the Patent (Score Weightage of m₈)

From the market point of view, the longer the duration of patent maintenance, the longer the economic lifespan of the patent. For a maintained patent for some number of years Y₂ (as calculated from the date of application after the grant of a patent), the associated score K₂ for a invention patent is as follows:

K₂=5

For a utility model patent,

K₂=10

Overall,

M₈=Y₂×K₂

Considering all of the above,

m₁+m₂+m₃+m₄+m₅+m₆+m₇+m₈=100%

And,

M=M₁×m₁+M₂×M₂+M₃×m₃+M₄×m₄+M₅×m₅+M₆×m₆+M₇×m₇+M₈×m₈

III. Technological Value (Score T)

1. Applicant's Research and Development Experience and General Experience in the Field (Score Weightage of t₁)

In an embodiment, an associated score of A₁ (with a weightage of C₁) is provided in regard of the total number of related patents (invention or utility model) held by the applicant under the same IPC type class/classes as the patent being valued. If there is more than one applicant, then the average score is used. An associated score of Y₃ in regard of the time lag between the application date of the applicant's first related patent applied for and the application date of the patent being valued is provided. The score T₁ is defined as:

T₁=C₁×A₁+(100%−C₁)×Y₃, 0≤C₁≤100%

2. Inventor's Research and Development Experience and General Experience in the Field (Score Weightage of t₂)

In an embodiment, an associated score of A₂ (with a weightage of C₂) is provided in regard of the total number of related patents (invention or utility model) with the inventor's name included, under the same IPC type class/classes as the patent being valued. If there is more than one inventor, then an average score is used. An associated score of Y₄ in regard of the time lag between the application date of the inventor's first related patent applied for and the application date of the patent being valued is provided. The score T₂ is defined as:

T₂=C₂×A₂+(100%−C₂)×Y₄, 0≤C₂≤100%

3. Citations of the Patent (Score Weightage of t₃)

In an embodiment, the more number of citations of the patent to be valued, the more significant the technical contribution of the patent; the score associated with this is C₃. When patents within more IPC type class/classes cite the patent that is being valued, the wider it is deemed the scope of application of the patent's technology. The associated score in regard of the number of patent citations is A₃ and that of the extent of diversification of IPC type class/classes is K₃. Overall, the score T₃ is as follows:

T₃=C₃×A₃+(100%−C₃)×K₃, 0≤C₃≤100%

4. Time Spent in Patent Application (Score Weightage o t₄)

The shorter the time taken for a patent to be granted from the date of application, the more important and more observed is the technology.

Y₅ is defined as the time taken for the patent to be granted from the date of application. In addition, K₄ for an invention patent is defined as follows:

K₄=20

For a utility model patent,

K₄=10

T₄ is defined as follows:

T₄=Y₅K₄, 0≤T₄≤100

5. Applicability of Technology (Score Weightage of t₅)

From a technological viewpoint, the longer a patent is maintained, the more mature the contained technology likely is and fewer technological substitutes are likely to be available. Even when a newer technology surfaces, because of the technical limitations imposed by the patent being valued, the newer technology may not able to replace the patent that is being valued.

Y₆ is defined as the number of years that the patent is maintained. In addition, K₅ for an invention patent is defined as follows:

K₅=5

For a utility model patent,

K₅=10

T₅ is defined as follows:

T₅=Y₆ K₅

6. How Advanced a Technology is (Score Weightage of t₆)

When some number of similar patents Y₇ are applied for and granted after the date of application of the patent considered for valuation, each of such granted patents provides a score of K₆. T₆ is defined as:

T₆=100−Y₇K₆, 0≤T₆≤100

7. Versatility of Technology (Score Weightage of t₇)

The complete breadth of classification by the IPC covers the following in turn: symbols of representative classes, main classes, subclasses, large or small groups; based on this system, the scope of a technical field accordingly decreases in turn. The score associated with the mentioned first category (symbols of representative classes) of patent IPC classification number is a₂ (with weightage V₁), The score associated with the mentioned second category (main classes) is b₂ (with weightage V₂). The score associated with the third category (small classes) is c₂ (with weightage V₃). The score associated with the fourth category (large or small groups) is d₂ (with a weightage of V₄). The overall score is:

T₇=V₁×a₂+V₂×b₂+V₃×c₂+V₄×d₂,

(V₁+V₂+V₃+V₄)=100%; V₁>V₂>V₃>V₄

8. Award-Winning Patent (Score Weightage of t₈)

In an embodiment, an award-winning patent is considered in the form of a top prize or a merit prize. For example, if a patent has won China's patent gold (top) prize, there is an associated score of A₄, where:

60≤A₄≤100

In a separate instance, if the patent has won a merit patent prize, there is an associated score of C₄, where:

30≤C₄≤60

Overall, T₈ is defined as follows:

$${T}_{8} = \{ \begin{matrix}{A}_{4} & where a top prize is awarded \\ {C}_{4} & where a merit prize is awarded \\ 0 & where no prize has been awarded\end{matrix}$$

Considering all of the abovementioned herein,

t₁+t₂+t₃+t₄+t₅+t₆+t₇+t₈=100%

And, the overall market value T of the patent valued is:

T=T₁×t₁+T₂×t₂+T₃×t₃+T₄×t₄+T₅×t₅+T₆×t₆+T₇×t₇+T₈×t₈

IV. Risk Module (Score of R)

1. Risk of Patent Work-Around (Score Weightage of r₁)

In an embodiment, the wider the scope of protection of a patent, the more difficult it is to work-around the patent; in this manner, the associated score is higher. The patent with the largest scope of protection in the target pool of data has an associated score of D₃; the patent that is to be valued has an associated score D₄ based on its scope of protection. R₁, the overall score in regard of the risk of patent work-around is:

$${R}_{1} = \frac{100 {D}_{4}}{{D}_{3}}$$

2. Risk in Ability to Gather Evidence of Infringement (Score Weightage of r₂)

The technical features of each independent claim of the patent under consideration are first analyzed; it is relatively easier to obtain evidence of infringement in regard of a structural feature. It is relatively more difficult to obtain evidence of infringement in regard of a method or usage. The lower the degree of difficulty in obtaining such evidence, the higher the associated score. For a structural feature, the associated score is W₁. For a method or usage, the associated score is W₂. The number of independent product claims containing structural features is J₄. The number of independent method or use claims is Z₆. The total number of independent claims is S. The risk in associated with the ability to gather evidence of infringement, R₂ is:

$${R}_{2} = {W}_{1} \times ( \frac{{J}_{4}}{S} ) + {W}_{2} \times ( \frac{{Z}_{6}}{S} ) , {W}_{1} + {W}_{2} = 100$$

3. Risk of Ease of Technology Substitution (Score Weightage of r₃)

The likelihood of a patent being replaced is lower when there are fewer similar patents; in this manner, the associated score will be higher.

The number of granted patents similar to (and granted prior to the application date of the patent under consideration) is a₃, with each such similar granted patent having an associated score of b₃. The number of granted patents similar to (and granted after the application date of the patent under consideration) is c₃, with each such similar patent having an associated score of d₃.

Herein, similarity refers to patents that have at least a 75% overlap with the technical characteristics of the patent to be valued. The associated score for the risk of ease of technology substitution is R₃ and as follows:

R₃=100−(a₃×b₃+c₃×d₃), 0≤R₃≤100

4. Legally Contentious Matters (Score Weightage of r₄)

The fewer legally contentious matters there are in the industry, the smaller the likelihood of legal struggles, leading to a higher associated score. The average number of legal matters for similar patents is a₄, and the associated score of each legal matter arising is b₄. The overall score in regard of legally contentious matters, R₄, is as follows:

R₄=100−(a₄×b₄),0≤a₄×b₄≤100

Considering the abovementioned factors herein:

r₁+r₂+r₃+r₄=100%, and

R=R₁×r₁+R₂×r₂+R₃×r₃+R₄×r₄

Combining the quantifiable and unquantifiable indicators of each factor and their basic quantification processes; the overall patent value is P:

P=(L+M+T)×R %

In an embodiment, the above-mentioned patent valuation system is based on computing technology, information from the Internet and the use of big data analysis.

In an embodiment, further to the steps as comprised in the method described in the aspect, based on the overall valuation of step (e), a monetary value may then be assigned to the patent or patents under consideration. Advantageously, such a further step of assigning monetary value or values provide a guide to the monetary worth of the patent or patents being considered and may be used as a comparative reference in the case that transactional motives are desired.

In another embodiment, the steps as comprised in the method described in the aspect may be carried out on one or more data servers. Advantageously, such an arrangement allows for the flexibility of the method to be implemented and scaled up accordingly as desired.

In another embodiment, the steps as comprised in the method described in the aspect may be carried out using at least one computing device. Advantageously, the use of at least one computing device allows the method to be implemented in a highly efficient manner by allowing data analytical processes to be carried out in an intensive fashion.

In another embodiment, each of the steps as comprised in the method described in the aspect may be carried out using at least a single, dedicated computing device. Advantageously, the use of at least a single, dedicated computing device allows the proper allocation of computing resources to support the overall implementation of the method, thus allowing faster data analyses to be carried out.

In another embodiment, each of the steps as comprised in the method described in the aspect may be hosted on at least a single, dedicated data server. Advantageously, such an arrangement reduces operational down time should any one single, dedicated data server hosting a step of the method be faulty or require time for maintenance.

The patent valuation system as put forth differs from technology in the present state of art in the following ways: the system optimizes a dynamic database and target data pool; it adopts a multi-level index evaluative process: the first level index includes the legal, technical and market values, together with the risk module for the patent. Further to this, there are several second-level indicators subordinate to the first-level indicators; these second-level indicators may yet further include multiple third-level valuation indicators. Such multi-level indicators strengthen the analytical depth of the patent valuation process. In this manner, unquantifiable indicators can be transformed into quantifiable indicators and evaluated. Based on the use of large data analysis, the breadth of analysis is increased. The application of the patent valuation system is highly practicable due to the use of a clear quantification process (additionally with the possibility of statistical analysis) which enables the various parameters involved to be quantified robustly. Overall, the patent value valuation system is objective, fair, highly efficient, comprehensive and highly practicable.

The above description is intended to serve as exemplary illustrations of the patent valuation system as claimed; they do not serve to limit the invention in any manner, degree or form. Any modification, equivalent replacement and improvement which can be carried out within the spirit and principles of the presently claimed patent valuation system is understood to be included in the scope of protection of the present invention.

### BRIEF DESCRIPTION OF DRAWINGS

The accompanying drawings illustrate disclosed embodiments and serve to explain the principles of the disclosed embodiments. It is to be understood, however, that the drawings are designed for purposes of illustration only, and not as a definition of the limits of the invention.

FIG. 1 shows the overall flow process of the patent valuation system.

FIG. 2 depicts the trend of the lifecycle of a technology.

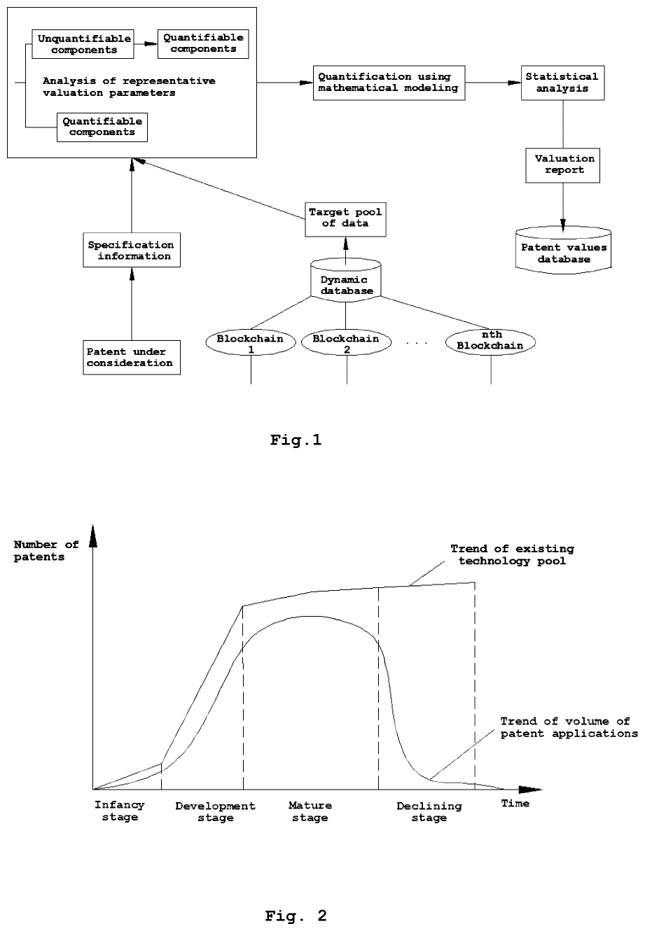

### EXAMPLES

Non-limiting examples of the invention will be further described in greater detail by reference to specific Examples. These examples should not be construed as in any way limiting the scope of the invention.

### Example 1

The dynamic database as established in the method of valuing patents is hosted on a cloud server. The database is dynamically updated real-time or at regular time intervals (for instance: once daily, twice daily, weekly, fortnightly or monthly).

### Example 2

The dynamic database as established in the method of valuing patents consists of data in English, French, German, Chinese, Russian, Dutch, Japanese, Korean, Bahasa Indonesia, Bahasa Melayu, Vietnamese and Thai.

### Example 3

The patent information as obtained and identified in the method of valuing patents consists of data in English, French, German, Chinese, Russian, Dutch, Japanese, Korean, Bahasa Indonesia, Bahasa Melayu, Vietnamese and Thai.

### Example 4

The dynamic database as established in the method of valuing patents consists of data in English, French, German, Chinese, Russian, Dutch, Japanese, Korean, Bahasa Indonesia, Bahasa Melayu, Vietnamese and Thai. The patent information as obtained and identified in the method of valuing patents also consists of data in English, French, German, Chinese, Russian, Dutch, Japanese, Korean, Bahasa Indonesia, Bahasa Melayu, Vietnamese and Thai.

### Example 5

The dynamic database as established in the method of valuing patents consists of data in English, French, German, Chinese, Russian, Dutch, Japanese, Korean, Bahasa Indonesia, Bahasa Melayu, Vietnamese and Thai. At the same time, the patent information as obtained and identified in the method of valuing patents consists of data in English only.

### Example 6

Two similar patents (namely, “patent A” and “patent B”) are separately subjected to the method of valuing patents. The overall valuation based on aggregated scores of each of the valuation parameters for patent A and patent B are 23.2 and 76.8 respectively, indicating that patent B is of a higher value than patent B.

### Example 7

Patent C, a patent that is similar to patent A and patent B (described in Example 6) is of an overall valuation of 92. Patent C has a recorded transaction price of USD 1 million. Taking the overall valuation of Patent C (i.e., 92) as the base score, the potential worth (monetary value) of patent A and patent B are assigned respectively:

(23.2/92)×USD 1 million=USD 252,174 A

(76.8/92)×USD 1 million=USD 834,783 B

### Example 8

The dynamic database of the method is established as an interface to a patent transaction platform or as interfaces to multiple transaction platforms. In the case of the single interface to a patent transaction platform, the platform is able to display to its users various indicators (for instance, valuation parameters and aggregated scores) of a related patent. In the case of multiple transaction platforms forming multiple interfaces with the dynamic database, all the transaction platforms subscribe to a common method of valuation. For instance, if patent A (as described in Example 7) is valued at USD 252,174 then this value is commonly subscribed to as the deemed monetary value of patent A on all the transaction platforms interfaced with, thereby creating a standard amongst the multiple platforms for the value of patent A.

### Example 9

The comprised steps of the method of valuing patents are carried out on one or more data servers. The data servers can be hosted in the cloud or hosted in a dedicated manner. These host servers may be spatially located in a single or multiple physical locations.

### Example 10

The comprised steps of the method of valuing patents are carried out using at least a computing device, for instance, a desktop computer, a mainframe computer, a laptop, a mobile phone or a tablet computer. Where the comprised steps of the method of valuing patents are carried out using more than one computing device, the computing devices are selected from the group consisting of: a desktop computer, a mainframe computer, a laptop, a mobile phone or a tablet computer.

### Example 11

Each of the comprised steps of the method of valuing patents are carried out using at least a single dedicated computing device. The dedicated computing device or devices can be selected from: a desktop computer, a mainframe computer, a laptop, a mobile phone or a tablet computer. Where more computing power is required to handle a relatively larger pool of data in any one particular step of the method of valuing patents, then, more than one dedicated computing device may be selected and implemented to do so.

### Example 12

Each of the comprised steps of the method of valuing patents are hosted on at least a single dedicated data server. These dedicated servers may be spatially located in a single or multiple physical locations.

### Example 13

The patent information obtained and identified in the method of valuing patents may be of any language, for instance, English and/or French. An online translation function may be implemented simultaneously to allow the patent information obtained and identified to be translated into a language of choice, e.g. English and/or French into Chinese.

### Example 14

The dynamic database as established in the method of valuing patents consists of data in Japanese. At the same time, the patent information as obtained and identified in the method of valuing patents consists of data in English only. An online translation function may be implemented simultaneously to allow the data in Japanese in the dynamic database and the patent information obtained and identified (in English) to be translated into a common language of choice, e.g. Chinese.

### Applications

The potential applications of the presently disclosed technology are wide-ranging and are described below:

The method of valuing patents in the present application may be incorporated as an interface to a patent transaction system. Such a patent transaction system can then advantageously provide not only a system for the sale and/or licensing of patents, but also possesses the ability to provide values of patents based on a standardized quantification process. With such a method, a person or company seeking to purchase a patent or a license based on a patent can be presented online with a reference (in terms of value and/or or a monetary worth) to the patent or license that is being sought. A comparison of the value and/or monetary worth of a pool of patents can also be carried out with the results stemming from the method of the present application being applied. In addition, the method can also be used to generate patent values and/or monetary worth at time intervals (for instance, monthly), thus creating a useful record of historical patent values and/or monetary worth for comparison in the future.

When used alone, or in combination with provided evidence of proof of use of a particular patented technology, the method of the present application can be used to siphon out patents which are not being practiced. Such patents are deemed to be wasteful in an economy because they essentially monopolize technologies in which society does not benefit from due to its non-practiced state.

In a merger and acquisition (M&A) scenario, where a company offers to buy another company with a portfolio of patents, a due diligence of the company that is being sought for the purchase is carried out, including that of its portfolio of patents. It may be tedious and costly to carry out a valuation (through human valuation services) of the individual patents within the portfolio of patents to deduce the overall value of the portfolio. The method in the present application is able to provide a quick and unbiased way (since the valuation process may be quantified using a standard set of parameters) to value each patent in the portfolio, either by the buyer or the seller.
When implemented using a large enough data pool, the method of the present application is able to provide a trend in the value and/or monetary worth of patents in the form of an industry average value or moving average value. This may be useful to economists and policy makers (e.g. the government of a country) to carry out analyses
   and make decisions in regard of the technology (research/development) and manufacturing sectors.

1. A method of valuing patents, comprising the following steps:
(a) Establishing a dynamic database;
(b) obtaining and identifying patent information;
(c) calling targeted information from the dynamic database in regard of the identified patent information to consequently form a target pool of data;
(d) establishing representative valuation parameters and comparing these representative valuation parameters against the identified patent information together with the target pool of data; additionally, using mathematical models to quantify and assign scores to these valuation parameters;
(e) aggregating the assigned scores of each of the valuation parameters and providing an overall valuation based on the aggregated scores.

2. The method of claim 1, further in which the patent information as obtained in step (b) comprises bibliographic details and patent claims; the patent information as identified comprises classification codes within the bibliographic details together with keywords from the patent claims.

3. The method of claim 2, further in which the target pool of data as formed in step (c) comprises a record of patents generated based on classification codes and/or keywords and a databank of technological knowledge generated based on keywords.

4. The method of claim 1, further in which the calling of targeted information in step (c) in regard of the identified patent information comprises the actions of searching, statistically analyzing and querying the dynamic database.

5. The method of claim 1, further in which the establishing of representative valuation parameters in step (d) comprises the creation of both quantifiable and unquantifiable indicators.

6. The method of claim 1, further in which the representative valuation parameters comprise of legal, technological and market valuation parameters.

7. The method of claim 6, further in which the legal valuation parameters comprise of the remaining years of patent protection, unity of invention, drafting quality, grant rate, historical legal status and/or novelty of invention;
the technological valuation parameters comprise the research experience and background of the patent applicant(s) or inventor(s) in the relevant technological field, patent citation(s), duration of patent application process, practicability of technology, how advanced a technology is, how versatile a technology is and if the patented technology has garnered any technological prize;
the market valuation parameters comprise details of the patent applicant(s), whether the patent applicant(s) is/are in a field related to the patent in consideration, market boundaries/conditions/strategies, license(s) issued, assignment(s) and the annual maintenance of the patent.

8. The method of claim 1, further in which the representative valuation parameters are subject to a multiple regression model and optimized using a least-square method Y=βX+ε, where Y is the dependent variable matrix, X is independent variable matrix, β is the coefficient matrix, ε is the residual matrix; β=(X′X)⁻¹(X′Y), X′ is the transpose matrix of X.

9. The method of claim 8, further in which an analysis of the independence between the representative valuation parameters is carried out through a likelihood function:
$$\{ \begin{matrix}LR 1 = - \frac{n}{2} \times ln ( 2 π \hat{σ} ) - {\sum }_{i} {( \frac{{ɛ}^{2}}{2 \hat{σ}} )}_{i} \\ LR 2 = - \frac{n}{2} \times ln ( 2 π \tilde{σ} ) - {\sum }_{i} {( \frac{{ɛ}^{2}}{2 \tilde{σ}} )}_{i} \\ LR = 2 [ LR 1 - LR 2 ]\end{matrix}$$
where LR1 refers to the likelihood function of an unconstrained equation, n is a selected number of data points, ∂ is the estimated variance of the unconstrained equation; LR2 refers to the likelihood function of a constrained equation, \tilde{σ} is the estimated variance of the constrained equation; LR1 and LR2 follow a chi-square distribution; n, i are both positive whole numbers.

10. The method of claim 1, further in which the dynamic database as established in step (a) is one of the nodes of at least one blockchain.

11. The method of claim 10, in which data maintenance within the dynamic database as established in step (a) is carried out by at least one of the participating nodes of the said at least one blockchain.

12. The method of claim 11, further in which the participating nodes form a blockchain alliance.

13. The method of claim 1, wherein the dynamic database as established in step (a) consists of data in at least one language.

14. The method of claim 1, wherein the said patent information as obtained and identified in step (b) may be of at least one language.

15. The method of claim 1, wherein the dynamic database as established in step (a) is established as an interface to at least a patent transaction platform.

16. The method of claim 1, further in which a monetary value is assigned based on the overall valuation.

17. The method of claim 1, wherein the as comprised steps are carried out on one or more data servers.

18. The method of claim 1, wherein the as comprised steps are carried out using at least one computing device.

19. The method of claim 1, wherein each of the comprised steps are carried out using at least a single, dedicated computing device.

20. The method of claim 1, wherein each of the comprised steps are hosted on at least a single, dedicated data server.
